(19) United States
(12) Patent Application Publication
(10) Pub. No.: US 2026/0112936 A1
(43) Pub. Date: Apr. 23, 2026

(54) STATOR AND ROTATING ELECTRIC MACHINE

(71) Applicant: Hitachi Astemo, Ltd., Hitachinaka-shi, Ibaraki (JP)

(72) Inventors: Takahito MURAKI, Tokyo (JP); Shinji YAMAZAKI, Hitachinaka-shi (JP)

(73) Assignee: Hitachi Astemo, Ltd., Hitachinaka-shi, Ibaraki (JP)

(21) Appl. No.: 19/106,533

(22) PCT Filed: Aug. 28, 2023
(86) PCT No.: PCT/JP2023/030916

§ 371 Date: Feb. 25, 2025

(30) Foreign Application Priority Data
Nov. 9, 2022 (JP) 2022-179444

(51) Int. Cl. H02K 3/34; H02K 1/16

(52) U.S. Cl. CPC H02K 3/345; H02K 1/165

(57) ABSTRACT

Provided is a stator which suppresses a decrease in a space factor of a stator coil inserted into a slot and is excellent in oil adhesion resistance. A stator includes an annular stator core, a plurality of slots arrayed in a circumferential direction on an inner peripheral side of the stator core and penetrating in an axial direction, an insulator having a sheet shape including a plurality of layers in which the layers are bonded by a first bonding method, the insulator being wound in a tubular shape along an inner wall of the slot in each of the plurality of slots, and a plurality of stator coils inserted into the insulator. The insulator has a first surface bonded to the inner wall of the slot by a second bonding method and a second surface opposite to the first surface bonded to the stator coil by the second bonding method.

### TECHNICAL FIELD

The present invention relates to a stator and a rotating electric machine.

### BACKGROUND ART

In a rotating electric machine for an automobile, insulation between a stator core and a stator coil is achieved by sandwiching an insulator between an inner wall of a slot provided in the stator core and the stator coil inserted in the slot.

PTL 1 is known as a technique relating to the insulator provided between the inner wall of the slot provided in the stator core and the stator coil inserted in the slot.

PTL 1 describes in paragraph 0035 and FIG. 5 that “an insulating sheet member 24 is interposed between an inner wall surface of each slot 25 of a stator core 22 and a conductor segment 23. The insulating sheet member 24 is formed by winding rectangular insulating paper in a rectangular tube shape in accordance with a sectional shape of the slot 25 in a direction perpendicular to an axis and is disposed along the inner wall surface of each slot 25”. PTL 1 describes in Paragraph 0036 and FIG. 8 that “as illustrated in FIG. 8, a folded portion 24b is formed by being folded back once or more (once in the present embodiment) in the axial direction radially outward at an end portion on the other end side of the insulating sheet member 24 in an axial direction, that is, at an end portion on a side where an inclined portion 23e is formed (second coil end group 21b side (see FIG. 2)). Therefore, the insulating paper is doubled at a portion where the folded portion 24b is formed. The insulating sheet member 24 is disposed in a state where at least a part of the folded portion 24b is accommodated in the slot 25”.

### CITATION LIST

### Patent Literature

PTL 1: JP 2014-168330 A

### SUMMARY OF INVENTION

### Technical Problem

That is, in the technique described in PTL 1, as described in FIG. 5 of PTL 1, the entire circumference of the stator coil is surrounded by the double insulator at the portion of the folded portion 24b.

However, the rotating electric machine is required to be small and have high output, and it is necessary to improve a space factor of the stator coil inserted into the slot in order to realize high output with a small stator.

Thus, the configuration illustrated in FIG. 5 of PTL 1 has a problem that a thickness of the insulator increases and the space factor decreases, and thus, miniaturization and high output of the rotating electric machine are hindered.

Therefore, an object of the present invention is to provide a stator and a rotating electric machine that suppress a decrease in a space factor of a stator coil inserted into a slot and are excellent in oil bonding resistance.

### Solution to Problem

In order to solve the above problems, a stator of the present invention includes, for example, an annular stator core, a plurality of slots arrayed in a circumferential direction on an inner peripheral side of the stator core and penetrating in an axial direction, an insulator having a sheet shape including a plurality of layers in which the layers are bonded by a first bonding method, the insulator being wound in a tubular shape along an inner wall of the slot in each of the plurality of slots, and a plurality of stator coils inserted into the insulator. The insulator has a first surface bonded to the inner wall of the slot by a second bonding method and a second surface opposite to the first surface bonded to the stator coil by the second bonding method, and a part of the insulator is folded back in a direction perpendicular to the axial direction, the inner wall of the slot facing the second surface at the folded portion having three surfaces or less, and at least a part of the second surface at the folded portion being bonded to the inner wall of the slot by the second bonding method.

In addition, the rotating electric machine of the present invention includes, for example, the stator.

### Advantageous Effects of Invention

According to the present invention, it is possible to provide the stator and the rotating electric machine which suppress the decrease in the space factor of the stator coil inserted into the slot and are excellent in the oil bonding resistance.

### BRIEF DESCRIPTION OF DRAWINGS

FIG. 1 is a perspective view of a stator.

FIG. 2 is a diagram for explaining a shape of a slot.

FIG. 3 is a diagram for explaining folding of an insulator in the slot.

FIG. 4 is a diagram for explaining another example of a shape of a stator coil.

FIG. 5 is a diagram for explaining another example of a folding direction of the insulator in the slot.

FIG. 6 is a sectional view of a rotating electric machine.

FIG. 7 is a diagram for explaining an insulator according to a comparative example of a strength test.

FIG. 8 is a diagram for explaining an insulator according to Example 1 of the strength test.

FIG. 9 is a diagram for explaining an insulator according to Example 2 of the strength test.

FIG. 10 is a diagram for explaining an insulator according to Example 3 of the strength test.

FIG. 11 is a diagram illustrating results of the strength tests.

### DESCRIPTION OF EMBODIMENTS

Hereinafter, the present invention will be described in detail with reference to the drawings. Note that, the present invention is not limited to examples to be described below. These embodiments are merely examples, and the present invention can be implemented in various modified and improved forms based on the knowledge of those skilled in the art. In addition, in the drawings used in the following description, common apparatuses and devices are denoted by the same reference signs, and the description of the apparatuses, devices, and operations already described above may be omitted.

### Rotating Electric Machine Using Insulator

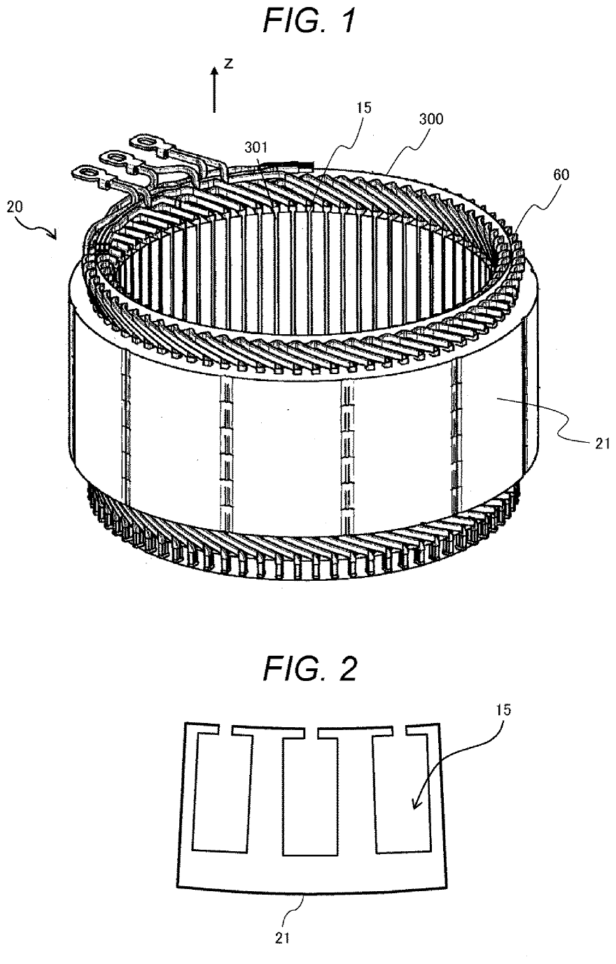

FIG. 1 is a perspective view of a stator. In the following description, “axial direction”, “circumferential direction”, and “radial direction” refer to an axial direction (z-axis direction in FIG. 1), a circumferential direction, and a radial direction of an annular stator 20 illustrated in FIG. 1. An “inner peripheral side” refers to a radially inner side (inner diameter side) of the stator 20, and an “outer peripheral side” refers to an opposite direction, that is, a radially outer side (outer diameter side) of the stator 20.

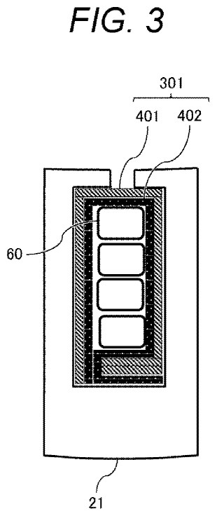

FIG. 2 is a diagram for explaining a shape of a slot. Specifically, FIG. 2 illustrates a part of a sectional view of a stator core 21 in a state where insulators 301 and stator coils 60 are not inserted, taken along a plane perpendicular to the axial direction. FIG. 3 is a diagram for explaining folding of the insulator in the slot.

Specifically, FIG. 3 illustrates a part of a sectional view of the stator core in a state where the insulator 301 and the stator coil 60 are inserted into slots 15. Note that, the configurations of FIGS. 2 and 3 are similar in any of the slots 15 provided in the stator core 21. In addition, in the following description, a stator used in a rotating electric machine of a hybrid car will be described, but the present invention is not limited thereto.

As illustrated in FIG. 1, the stator 20 includes the slots 15, the stator core 21, and the stator coil 60.

The stator core 21 has an annular shape. The stator core 21 is formed by stacking thin plates made of, for example, silicon steel plates.

As illustrated in FIG. 1, a plurality of slots 15 are arrayed in the circumferential direction on the inner peripheral side of the stator core 21. In addition, the slots 15 penetrates the stator core 21 in the axial direction. As illustrated in FIG. 2, the slot 15 has an opening portion on the inner peripheral side. Note that, in FIG. 2, a longitudinal direction of the slot 15 corresponds to the radial direction of the stator 20, and a lateral direction of the slot 15 corresponds to the circumferential direction of the stator 20.

As illustrated in FIG. 1, the stator coil 60 is wound around the plurality of slots 15 provided on the inner peripheral side of the stator core 21 by a wave winding method. In the present embodiment, the wave winding method is adopted as the winding method, but the winding method is not limited thereto as long as the winding method is a distributed winding method. Note that, in the present embodiment, the description has been given of an inner rotation type in which the slots 15 are on the inner peripheral side of the stator core 21, but the present invention is similarly applicable to an outer rotation type in which the slots 15 are on the outer peripheral side of the stator core 21.

In addition, as illustrated in FIG. 3, the stator coil 60 uses a conductor such as a copper wire having an insulating film having a substantially rectangular section. A coil having a substantially rectangular section is used, and thus, a space factor in the slot 15 is improved.

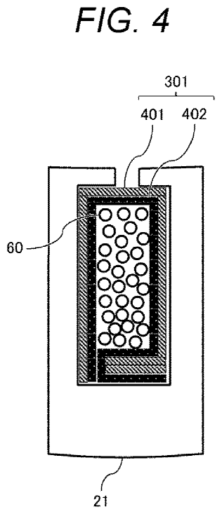

Note that, FIG. 4 is a diagram for explaining another example of a shape of the stator coil. Specifically, FIG. 4 illustrates a part of a sectional view of the stator core in which the insulator 301 and the stator coil 60 are inserted into the slot 15. As illustrated in FIG. 4, a round enameled wire can also be used as the stator coil 60.

As illustrated in FIG. 3, the insulator 301 includes a surface material 401 forming a first surface and a core material 402 forming a second surface, and the surface material 401 and the core material 402 are bonded by a first bonding method. Note that, examples of the first bonding method for bonding the surface material 401 and the core material 402 include bonding by thermal fusion, and bonding by an adhesive.

The insulator 301 is wound in a tubular shape along an inner wall of the slot 15. At this time, the insulator 301 is folded back in a direction perpendicular to the axial direction and the inner wall of the slot 15 facing the core material 402 at a folded portion has three surfaces or less. FIG. 3 illustrates, as an example of the insulator 301, a case where a part of the insulator 301 is folded back in the circumferential direction that is the direction perpendicular to the axial direction, and the inner wall of the slot 15 facing the core material 402 at the folded portion has one surface. Note that, although FIG. 3 illustrates an example in which both one end of the insulator 301 and the core material 402 at the folded portion face the same one surface of the inner wall of the slot 15, the present invention is not limited thereto.

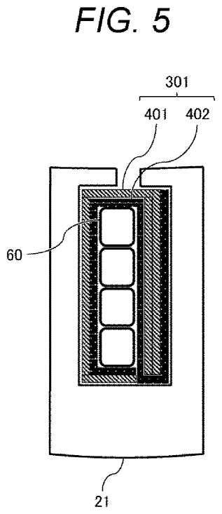

FIG. 5 is a diagram for explaining another example of a direction in which the insulator is folded back in the slot. Specifically, similarly to FIG. 3, FIG. 5 illustrates a part of a sectional view of the stator core in a state where the insulator 301 and the stator coil 60 are inserted into the slot 15. In the insulator 301, the core material 402 at the folded portion may face the inner wall of the slot 15 in the lateral direction as illustrated in FIG. 3, or the core material 402 at the folded portion may face the inner wall of the slot 15 in the longitudinal direction as illustrated in FIG. 5. However, the space factor can be improved by providing the insulator 301 such that the number of folded double portions of the insulator 301 is reduced. For example, when the insulator 301 of FIG. 3 is compared with the insulator 301 of FIG. 5, since the insulator 301 of FIG. 3 has fewer double portions, the space factor can be further improved than the configuration of FIG. 5 by providing the insulator 301 as illustrated in FIG. 3.

After the stator coil 60 and the insulator 301 are inserted into the slot 15 as illustrated in FIGS. 3 to 5, the stator coil 60 and the insulator 301 are bonded and the inner wall of the slot 15 and the insulator 301 are bonded by a second bonding method. As the second bonding method, as will be described later, the stator coil 60 and the insulator 301 may be bonded and the inner wall of the slot 15 and the insulator 301 may be bonded with a fixing varnish or a foamed adhesive. In a case where the fixing varnish is used, the fixing varnish is impregnated between the stator coil 60 and the insulator 301 and between the inner wall of the slot 15 and the insulator 301, and is then heated and cured. In addition, in a case where the foamed adhesive is used, the foamed adhesive is applied between the stator coil 60 and the insulator 301 and between the inner wall of the slot 15 and the insulator 301, and one or both of induction heating and energization heating to the stator coil are performed to heat and cure the foamed adhesive.

By doing this, the insulator 301 is provided in each slot 15, and thus, electrical insulation between the stator core 21 and the stator coil 60 is ensured.

In addition, as illustrated in FIGS. 3 to 5, the insulator 301 is molded in a square shape so as to package the stator coil 60 along the inner wall of the slot 15, and the stator coil 60 and the core material 402 face each other. Further, the insulator 301 is folded back in the direction perpendicular to the axial direction, and an inner wall of the stator core 21 facing the core material 402 at the folded portion has three surfaces or less. With this structure, since a portion where the insulator becomes double due to the folding of the insulator 301 and a thickness of the insulator 301 increases is not the entire circumference of the stator coil 60, a decrease in the space factor can be suppressed.

Note that, as illustrated in FIG. 1, the stator 20 may include annular insulating paper 300.

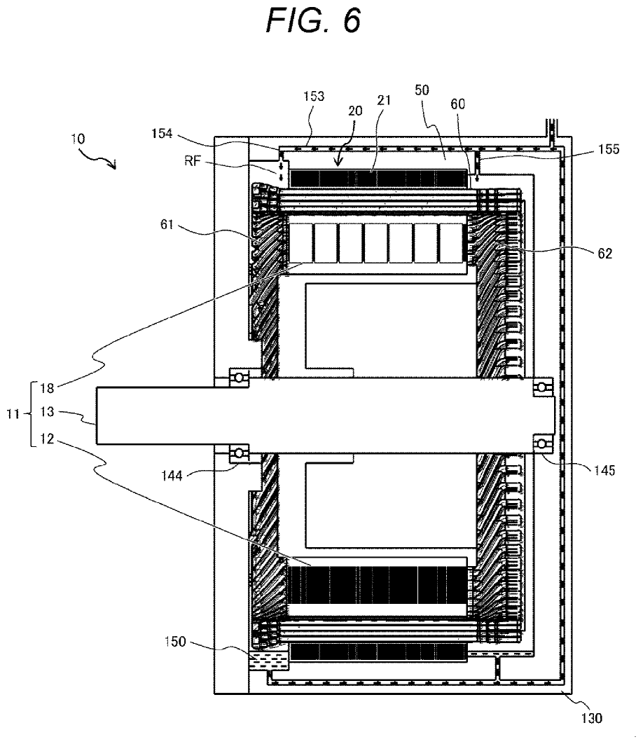

FIG. 6 is a sectional view of the rotating electric machine. In addition to the stator 20 described above, the rotating electric machine 10 includes a rotor 11, a housing 50, and a liquid-cooling jacket 130.

The rotor 11 is rotatably supported on the inner peripheral side of the stator 20. The rotor 11 includes a rotor core 12, a rotating shaft 13, a permanent magnet 18, and an end ring (not illustrated).

The rotor core 12 is formed by stacking thin plates of silicon steel plates. The rotating shaft 13 is fixed to a center of the rotor core 12. The rotating shaft 13 is rotatably held by bearings 144 and 145 attached to the liquid-cooling jacket 130, and rotates at a predetermined position in the stator 20 at a position facing the stator 20.

The housing 50 is fixed to the outer peripheral side of the stator 20. The housing 50 constitutes an outer sheath of an electric motor formed into a cylindrical shape by cutting an iron-based material such as carbon steel, casting cast steel or an aluminum alloy, or press processing. The housing 50 is also referred to as a frame body or a frame.

The liquid-cooling jacket 130 is fixed to the outer peripheral side of the housing 50. An inner peripheral wall of the liquid-cooling jacket 130 and an outer peripheral wall of the housing 50 form a refrigerant passage 153 of a liquid refrigerant RF such as oil, and the refrigerant passage 153 is formed so as not to leak a liquid. The liquid-cooling jacket 130 houses the bearings 144 and 145, and is also referred to as a bearing bracket.

The refrigerant RF passes through the refrigerant passage 153, flows out from refrigerant outlets 154 and 155 toward the stator 20, and cools the stator 20. A part of the refrigerant RF flowing out of the stator 20 flows into the refrigerant passage 153 via a refrigerant storage space 150. Such a cooling method is referred to as direct liquid cooling. Note that, examples of the refrigerant RF include oil. Hereinafter, the refrigerant RF will be described as oil.

Heat generated from the stator coil 60 is transferred to the housing 50 via the stator core 21, and is dissipated by the refrigerant RF flowing in the liquid-cooling jacket 130.

In assembling the rotating electric machine, the stator 20 is inserted into the housing 50 in advance and is attached to an inner peripheral wall of the housing 50, and then the rotor 11 is inserted into the stator 20. Subsequently, the bearings 144 and 145 are assembled to the liquid-cooling jacket 130 so as to be fitted to the rotating shaft 13.

While such direct liquid cooling has an advantage of high cooling efficiency, since oil which is the refrigerant RF is transferred to the insulator 301 between the inner wall of the slot 15 and the stator coil 60, the insulator 301 requires oil resistance performance. In a case where the oil resistance performance of the insulator 301 is low, that is, in a case where an adhesive that hydrolyzes with moisture in oil is used for bonding between the surface material 401 and the core material 402, bonding strength between the surface material 401 and the core material 402 decreases.

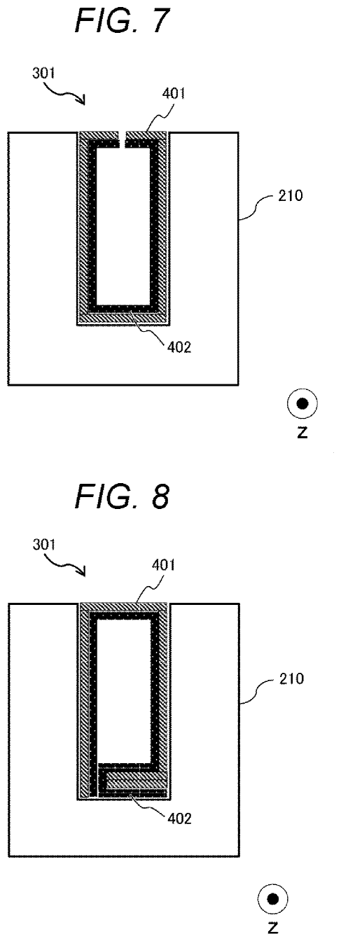

FIG. 7 is a diagram for explaining an insulator according to a comparative example of a strength test to be described later, and is a diagram illustrating an example of the insulator 301 that is not folded back. Note that, 210 is stainless steel imitating the stator core 21 as will be described later. The insulator 301 illustrated in FIG. 7 has a configuration in which the surface material 401 is disposed on an outer periphery of the insulator 301 and the core material 402 is disposed on an inner periphery of the insulator 301.

When the insulator 301 illustrated in FIG. 7 is inserted into the slot 15 of the stator core 21 illustrated in FIG. 2 and the stator coil 60 is inserted and bonded inside the inserted insulator 301, the inner wall of the stator core 21 is bonded to the surface material 401, and the stator coil 60 is bonded to the core material 402. Thus, in the configuration of the insulator 301 illustrated in FIG. 7, when the bonding strength between the surface material 401 and the core material 402 decreases, the core material 402 is peeled off from the surface material 401, and thus, the stator coil 60 bonded to the core material 402 is not fixed to the inner wall of the stator core 21.

However, in the insulator 301 illustrated in FIG. 3, the core material 402 is bonded to the stator coil 60 by the second bonding method having high oil resistance, and both the surface material 401 and the core material 402 are bonded to the inner wall of the stator core 21 by the second bonding method having high oil resistance. With such a configuration, even though the bonding strength between the surface material 401 and the core material 402 decreases and the core material 402 is peeled off from the surface material 401, the bonding between the stator coil 60 and the inner wall of the stator core 21 is secured.

Note that, in a case where the inner wall of the slot 15 facing the core material 402 at the folded portion has one surface, as illustrated in FIGS. 3 to 5, the core material 402 at the folded portion desirably faces the inner wall of the slot 15 without an opening. Accordingly, bonding strength between the core material 402 at the folded portion and the inner wall of the slot 15 can be secured. In addition, in a case where the inner wall of the slot 15 facing the folded core material 402 has three surfaces, that is, in a case where the inner wall of the slot 15 facing the surface material 401 has one surface, the surface material 401 desirably faces the inner wall of the slot 15 without the opening. Accordingly, the bonding strength between the surface material 401 and the inner wall of the slot 15 can be secured.

In addition, in a case where the inner wall of the slot 15 facing the core material 402 at the folded portion has two or three surfaces, since a contact area between the core material 402 at the folded portion and the inner wall of the slot 15 is large, there is no problem even though the core material 402 at the folded portion faces the inner wall of the slot 15 having the opening. The same applies to the surface material 401.

### Configuration of Insulator

A specific configuration example of the insulator 301 will be described. The surface material 401 is made of a nonwoven fabric of a thermoplastic resin film or a thermoplastic resin. The thermoplastic resin used as the surface material 401 is not particularly limited, and for example, a vinyl resin such as polyethylene or polypropylene, or a polyester resin such as polylactide, polycaproic acid, polybutylene succinate, polyethylene terephthalate, polybutylene terephthalate, or polyethylene naphthalate can be used. In addition, polyamide resins such as Nomex (registered trademark) including m-phenylenediamine and isophthalic acid, nylon 6, nylon 66, and nylon 6T can also be used. In addition, various engineering plastics such as polyphenylene sulfide, polyether ether ketone, and polyimide can also be used. Among these materials, from a viewpoint of heat resistance, a polyamide resin (aramid resin) including an aromatic compound, for example, Nomex (registered trademark) is preferable.

The core material 402 is formed of a thermoplastic resin film. The thermoplastic resin to be used is not particularly limited, and for example, a vinyl resin such as polyethylene or polypropylene, or a polyester resin such as polylactide, polycaproic acid, polybutylene succinate, polyethylene terephthalate, polybutylene terephthalate, or polyethylene naphthalate can be used. In addition, various engineering plastics such as polyphenylene sulfide, polyether ether ketone, and polyimide can also be used. Among these materials, from a viewpoint of processability and heat resistance, a polyester resin or a polyimide resin having an aromatic compound such as polyethylene terephthalate or polyethylene naphthalate is preferable.

In addition, a nonwoven fabric made of another kind of thermoplastic resin film or thermoplastic resin may be bonded to a surface of the core material 402 that is not in contact with the surface material 401. The thermoplastic resin to be used is not particularly limited, and for example, a vinyl resin such as polyethylene or polypropylene, or a polyester resin such as polylactide, polycaproic acid, polybutylene succinate, polyethylene terephthalate, polybutylene terephthalate, or polyethylene naphthalate can be used. In addition, polyamide resins such as Nomex (registered trademark) including m-phenylenediamine and isophthalic acid, nylon 6, nylon 66, and nylon 6T can also be used. In addition, various engineering plastics such as polyphenylene sulfide, polyether ether ketone, and polyimide can also be used. A method for bonding the nonwoven fabric made of another kind of thermoplastic resin film or thermoplastic resin to the surface of the core material 402 that is not in contact with the surface material 401 is not particularly limited, but heat fusion, bonding using an adhesive, or the like is preferable.

### Configuration of Foamed Adhesive

The foamed adhesive used between the insulator 301 (thermoplastic resin layer) and the stator coil 60 and between the insulator 301 and the inner wall of the stator core 21 are made of a thermosetting resin and a microcapsule type foaming agent. Examples of the thermosetting resin include an epoxy resin, an unsaturated polyester resin, a vinyl ester resin, and a urethane resin, and the epoxy resin, the unsaturated polyester resin, and the vinyl ester resin are preferable from a viewpoint of heat resistance and oil resistance.

The epoxy resin is not particularly limited, and examples thereof include a bisphenol type epoxy resin such as bisphenol A type, bisphenol F type, or dimer acid-modified bisphenol A type, a novolac type epoxy resin such as phenol novolac type or cresol novolac type, a biphenyl type epoxy resin, and a triphenylmethane type epoxy resin. Only one kind of these epoxy resin may be used or a combination of two or more kinds thereof may be used as appropriate. In addition, examples of a curing agent for the epoxy resin include an acid anhydride, phenol, phenol novolac, and dicyandiamide.

The unsaturated polyester resin is not particularly limited, and is obtained by dissolving a condensate obtained from a dibasic acid and a polyhydric alcohol in a radical polymerizable monomer. Examples of the dibasic acid used as a raw material of the unsaturated polyester resin include α, β-unsaturated dibasic acids such as maleic acid, maleic anhydride, fumaric acid, itaconic acid, and itaconic acid anhydride, and saturated dibasic acids such as phthalic acid, phthalic anhydride, isophthalic acid, terephthalic acid, tetrahydrophthalic acid, tetrahydrophthalic anhydride, hexahydrophthalic acid, hexahydroisophthalic acid, hexahydroterephthalic acid, succinic acid, malonic acid, glutaric acid, adipic acid, sebacic acid, 1,10 decanedicarboxylic acid, 2,6-naphthalenedicarboxylic acid, 2,7-naphthalenedicarboxylic acid, 2,3-naphthalenedicarboxylic acid, 2,3-naphthalenedicarboxylic acid anhydride, 4,4′-biphenyldicarboxylic acid, and dialkyl esters thereof. However, the present invention is not particularly limited to these compounds. Only one kind of these dibasic acids and the like may be used, or a combination of two or more kinds thereof may be used as appropriate.

Examples of the polyhydric alcohols used as a raw material of the unsaturated polyester resin include ethylene glycol, diethylene glycol, triethylene glycol, polyethylene glycol, propylene glycol, dipropylene glycol, polypropylene glycol, 2-methyl-1,3-propanediol, 1,3-butanediol, an adduct of bisphenol A and propylene oxide or ethylene oxide, glycerin, trimethylolpropane, 1,3-propanediol, 1,2-cyclohexaneglycol, 1,3-cyclohexaneglycol, 1,4-cyclohexaneglycol, paraxylene glycol, bicyclohexyl-4,4′-diol, 2,6-decalin glycol, and tris (2-hydroxyethyl) isocyanurate. However, the present invention is not particularly limited to these compounds. In addition, amino alcohols such as ethanolamine may be used. Only one kind of these polyhydric alcohols may be used, or a combination of two or more kinds thereof may be used as appropriate. In addition, as necessary, a dicyclopentadiene compound may be incorporated in a resin skeleton.

Examples of the epoxy compound used as a raw material of the vinyl ester resin include a compound having at least two epoxy groups in a molecule. Examples of such an epoxy compound include an epibis-type glycidyl ether type epoxy resin obtained by a condensation reaction between bisphenols such as bisphenol A, bisphenol F, or bisphenol S and epihalohydrin, a novolac-type glycidyl ether-type epoxy resin obtained by a condensation reaction between novolac which is a condensate of phenols such as phenol, cresol, or bisphenol and formalin and epihalohydrin, a glycidyl ester type epoxy resin obtained by a condensation reaction between tetrahydrophthalic acid and epihalohydrin or a condensation reaction between hexahydrophthalic acid and epihalohydrin, a condensation reaction between at least one of 4,4′-biphenol, 2,6-naphthalenediol, or hydrogenated bisphenol and epihalohydrin, or a glycidyl ether type epoxy resin obtained by a condensation reaction between glycols and epihalohydrin, an amine-containing glycidyl ether type epoxy resin obtained by a condensation reaction between hydantoin and epihalohydrin or condensation reaction between cyanuric acid and epihalohydrin, or the like can be used. However, the present invention is not particularly limited to these compounds. One kind of these epoxy compounds may be used, or a combination of two or more kinds thereof may be used as appropriate.

Examples of the unsaturated monobasic acid used as a raw material of the vinyl ester resin include acrylic acid, methacrylic acid, and crotonic acid. In addition, a half ester such as maleic acid or itaconic acid may be used. However, the present invention is not particularly limited thereto. One kind of these unsaturated monobasic acid may be used, or a combination of two or more kinds thereof may be used as appropriate.

Other optional components may be added to the resin composition as necessary. Examples of the optional component include a radical polymerizable monomer, a polymerization initiator, a curing accelerator, a polymerization inhibitor, and a bonding strength improving agent.

Examples of the radical polymerizable monomer include styrene, vinyl toluene, vinyl naphthalene, α-methylstyrene, vinylpyrrolidone, acrylamide, acrylonitrile, allyl alcohol, allyl phenyl ether, (meth)acrylic acid ester, vinyl acetate, vinyl pyrrolidone, (meth)acrylamide, maleic acid diester, and fumaric acid diester.

However, the present invention is not particularly limited to these compounds. Styrene, vinyltoluene, and (meth)acrylic acid ester (for example, methacrylate and acrylate) are preferably used. Examples of the (meth)acrylic acid ester include (meth)acrylates having isocyanato groups such as methyl (meth)acrylate, ethyl (meth)acrylate, propyl (meth)acrylate, butyl (meth)acrylate, 2-ethylhexyl (meth)acrylate, isooctyl (meth)acrylate, isodecyl (meth)acrylate, benzyl (meth)acrylate, phenyl (meth)acrylate, cyclohexyl (meth)acrylate, dicyclopentanyl (meth)acrylate, dicyclopentenyl (meth)acrylate, isobornyl (meth)acrylate, methoxylated cyclotriene (meth)acrylate, dicyclopentenyloxyethyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, polyethylene glycol (meth)acrylate, alkyloxypolypropylene glycol (meth)acrylate, tetrahydrofuryl (meth)acrylate, 2-hydroxy-3-phenoxypropyl (meth)acrylate, glycidyl (meth)acrylate, caprolactone-modified tetrafurfuryl (meth)acrylate, ethoxycarbonylmethyl (meth)acrylate, 2-ethylhexylcarbitol acrylate, 1,4-butanediol (meth)acrylate, acrylonitrile butadiene methacrylate, dicyclopentenyloxyethyl methacrylate, 2-methacryloyloxyethyl isocyanate, and 2-methacryloyloxyethoxyethyl isocyanate, and (meth)acrylates having isocyanate-derived groups such as 2-(0-[1′methylpropylideneamino]carboxyamino)ethyl methacrylate and 2-(1′[2,4dimethylpyrazonyl]carboxyamino)ethyl methacrylate. One kind of these compounds may be used, or a combination of two or more kinds thereof may be used as appropriate. Preferably, (meth)acrylates which do not inhibit the decomposition of a photopolymerization initiator and have high reactivity are preferable.

Examples of the polymerization initiator, benzoyl peroxide, lauroyl peroxide, t-butyl peroxide, t-amyl peroxide, t-amyl peroxineodecanoate, t-butyl peroxineodecanoate, t-amyl peroxyisobutyrate, di(t-butyl)peroxide, dicumyl peroxide, cumene hydroperoxide, 1,1-di(t-butylperoxy)cyclohexane, 2,2-di(t-butylperoxy) butane, t-butyl hydroperoxide, di(s-butyl) peroxycarbonate, and methyl ethyl ketone peroxide. Only one kind of these compounds may be used, or a combination of two or more kinds thereof may be used as appropriate. Among these compounds, from a viewpoint of the curing temperature, a compound having a 1 hour half-life temperature in a range of 100° C. to 150° C., such as 1,1-di(t-butylperoxy)cyclohexane, is desirable.

Examples of the curing accelerator include metal salts of naphthenic acid or octylic acid (metal salts such as cobalt, zinc, zirconium, manganese, and calcium). Only one kind of these materials may be used, or a combination of two or more kinds thereof may be used as appropriate.

Examples of the polymerization inhibitor include quinones such as hydroquinone, para-tertiary butylcatechol, and pyrogallol. Only one kind of these materials may be used, or a combination of two or more kinds thereof may be used as appropriate.

Examples of the bonding strength improving agent include p-styryltrimethoxysilane, 3-methacryloxypropyltrimethoxysilane, and 3-methacryloxypropyltriethoxysilane. Only one kind of these materials may be used, or a combination of two or more kinds thereof may be used as appropriate.

In addition, the microcapsule type foaming agent is not particularly limited, and may have, for example, a structure having a core-shell structure in which a volatile solvent is wrapped with an acrylic resin. A synthesis method is not particularly limited, and an interfacial polymerization method, an in situ method, or the like can be applied.

Further, silica, alumina, or the like may be added as a filler in order to enhance heat resistance and strength.

### Verification of Folded Shape

Comparison was made between Examples 1 to 3 and the comparative example by using Nomex (registered trademark) which is an aromatic polyimide resin nonwoven fabric as the surface material 401 and using the insulator 301 using insulating paper NHN manufactured by SUI ON INSULATING CO., LTD., which is a polyimide film as the core material 402, to verify an effect of folding back the insulator 301.

### Example 1

FIG. 8 is a diagram for explaining an insulator according to Example 1 of the strength test. A folding method of the insulator 301 illustrated in FIG. 8 is similar to the folding method illustrated in FIG. 3. The stainless steel 210 simulates the stator core 21. Specifically, the stainless steel 210 is a rectangular parallelepiped block of a stainless steel having a length of 100 mm in the z-axis direction, and has a recessed cutout penetrating in the z-axis direction. Note that, in order to easily perform the test, an opening portion of the stainless steel 210 has a configuration different from the configuration of the stator core 21. The configuration of the stainless steel 210 is similar to configurations in Example 2, Example 3, and the comparative example. The insulator 301 folded back in the shape of FIG. 8 is installed in such the recessed cutout portion of the stainless steel 210. Note that, as illustrated in FIG. 8, a folding position is a recessed bottom portion. One enameled wire (not illustrated) having a substantially rectangular section and a length of 200 mm is inserted into the insulator 301. A test piece of Example 1 in which the stainless steel 210, the insulator 301, and the enameled wire are fixed is obtained by applying a liquid obtained by mixing 100 parts by weight of a fixing varnish WP-2008 manufactured by Resonac Corporation and 1.5 parts by weight of a polymerization initiator CT-50 and heating and curing the liquid at 130° C. for 1 hour.

### Example 2

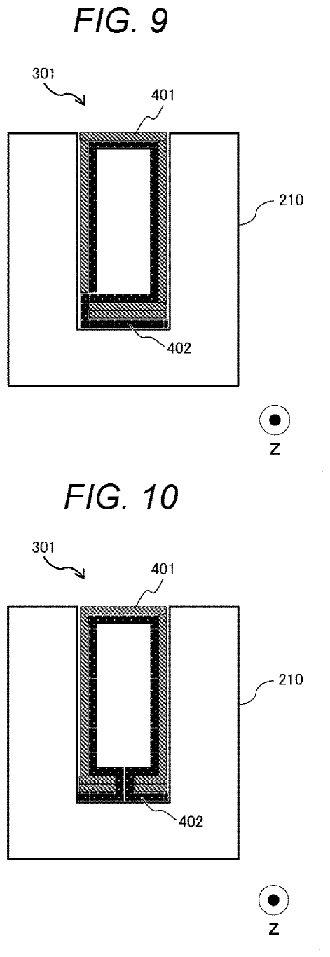

FIG. 9 is a diagram for explaining an insulator according to Example 2 of the strength test. FIG. 9 illustrates an example in which only one end of the insulator 301 is folded back and the core material 402 at the folded portion faces the entire one surface of the inner wall of the slot 15. The insulating paper folded back into the shape of FIG. 9 is installed in the recessed cutout portion of the stainless steel 210. Note that, a folding position is a recessed bottom portion. The test piece of Example 2 has conditions similar to the conditions of Example 1 except for the folding method of the insulator 301.

### Example 3

FIG. 10 is a diagram for explaining an insulator according to Example 3 of the strength test. FIG. 10 illustrates an example in which both ends of the insulator 301 are folded back and both sides of the core material 402 at the folded portion face the same one surface of the inner wall of the slot 15. The insulator 301 folded back in the shape of FIG. 10 is installed in the recessed cutout portion of the stainless steel 210. Note that, a folding position is a recessed bottom portion. The test piece of Example 3 has conditions similar to the conditions of Example 1 except for the folding method of the insulator 301.

### comparative Example

FIG. 7 is a diagram for explaining an insulator according to a comparative example of the strength test as described above. The insulator 301 illustrated in FIG. 7 is not folded back. The insulator 301 having the shape of FIG. 7 is installed in the recessed cutout portion of the stainless steel 210. The test piece of a comparative example has conditions similar to the conditions of Example 1 except that the insulator 301 is not folded back.

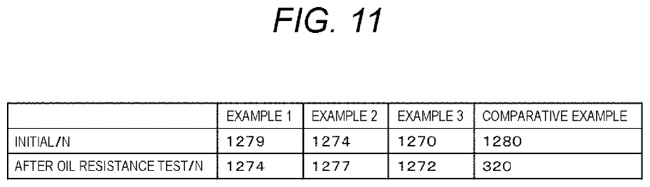

The test pieces of Examples 1 to 3 and the comparative example are immersed in DEXRON (registered trademark)-VI automatic transmission fluid manufactured by ACDelco to which 0.2 wt% of water is added, and is heated at 180° C. for 1000 hours. As for the test pieces, a pull-out test was performed at a pulling speed of 50 mm/min by using a universal testing machine AG-X manufactured by Shimadzu Corporation, and pull-out strengths were compared. FIG. 11 illustrates the results of the strength test. Note that, N in FIG. 11 represents Newton.

In Examples 1, 2, and 3, the pull-out strengths were equivalent to an initial strength even after an oil resistance test, and fracture occurred between the stainless steel 210 and the insulator 301. On the other hand, in the comparative example, the pull-out strength was reduced, and fracture occurred at an interface between the surface material 401 and the core material 402.

From the above results, it was confirmed that the oil bonding resistance was improved by using the shapes of Examples 1 to 3.

Although the permanent magnet type rotating electric machine has been described above, since the features of the present invention relate to the insulation of the stator coil, the rotor is not of the permanent magnet type, and can be applied to an induction type, a synchronous reluctance, a claw-pole type, and the like.

### REFERENCE SIGNS LIST

10 rotating electric machine
11 rotor
12 rotor core
13 rotating shaft
15 slot
18 permanent magnet
20 stator
21 stator core
50 housing
60 stator coil
61 anti-welding-side coil end
62 welding-side coil end
130 liquid-cooling jacket
144 bearing
145 bearing
150 refrigerant (oil) storage space
153 refrigerant passage
154 refrigerant outlet
155 refrigerant outlet
210 stainless steel
300 annular insulating paper
301 insulator
401 surface material
402 core material
RF refrigerant

1. A stator comprising:
an annular stator core;
a plurality of slots arrayed in a circumferential direction on an inner peripheral side of the stator core and penetrating in an axial direction;
an insulator having a sheet shape including a plurality of layers in which the layers are bonded by a first bonding method, the insulator being wound in a tubular shape along an inner wall of the slot in each of the plurality of slots; and
a plurality of stator coils inserted into the insulator,
wherein
the insulator has a first surface bonded to the inner wall of the slot by a second bonding method and a second surface opposite to the first surface bonded to the stator coil by the second bonding method,
and a part of the insulator is folded back in a direction perpendicular to the axial direction, the inner wall of the slot facing the second surface at a folded portion having three surfaces or less, and at least a part of the second surface at the folded portion being bonded to the inner wall of the slot by the second bonding method.

2. The stator according to claim 1, wherein, in the insulator, the inner wall of the slot facing the second surface at the folded portion has one surface.

3. The stator according to claim 2, wherein
the slot has a rectangular shape in a section perpendicular to the axial direction, a lateral direction being the circumferential direction, and
a part of the insulator is folded back in the circumferential direction.

4. The stator according to claim 2, wherein
the slot has a rectangular shape in a section perpendicular to the axial direction, a lateral direction being the circumferential direction, and
a part of the insulator is folded back in a radial direction of the stator core.

5. The stator according to claim 2, wherein
the slot has an opening portion on the inner peripheral side, and
the insulator has the first surface in contact with the opening portion.

6. The stator according to claim 1, wherein the first bonding method is bonding using an adhesive that hydrolyzes with moisture contained in a refrigerant that cools the stator coil.

7. The stator according to claim 1, wherein the second surface includes any one of polyimide, polyphenylene sulfide, and a polyester resin.

8. The stator according to claim 1, wherein the first surface is made of an aramid resin.

9. The stator according to claim 1, wherein the second bonding method is bonding using a thermosetting resin.

10. A rotating electric machine comprising the stator according to claim 1.

11. The rotating electric machine according to claim 10, further comprising a liquid-cooled jacket that is provided on an outer peripheral side of the stator and cools the stator by causing a refrigerant to flow to the stator.
